(19) United States
(12) Patent Application Publication
(10) Pub. No.: US 2013/0200136 A1
(43) Pub. Date: Aug. 8, 2013

(54) REFLOW SOLDERING DEVICE AND REFLOW SOLDERING METHOD

(71) Applicants: Noriyuki Besshi, Chiyoda-ku (JP); Dai Nakajima, Chiyoda-ku (JP); Hirotoshi Maekawa, Chiyoda-ku (JP); Satoshi Ishibashi, Chiyoda-ku (JP)

(72) Inventors: Noriyuki Besshi, Chiyoda-ku (JP); Dai Nakajima, Chiyoda-ku (JP); Hirotoshi Maekawa, Chiyoda-ku (JP); Satoshi Ishibashi, Chiyoda-ku (JP)

(73) Assignee: Mitsubishi Electric Corporation, Tokyo (JP)

(21) Appl. No.: 13/879,510

(22) PCT Filed: May 30, 2011
(86) PCT No.: PCT/JP2011/062361

§ 371 Date: Apr. 15, 2013

(30) Foreign Application Priority Data
Nov. 23, 2010 (JP) 2010-260712

(51) Int. Cl. B23K 31/02; B23K 3/08

(52) U.S. Cl. CPC B23K 31/02; B23K 3/082
USPC 228/219; 228/42

(57) ABSTRACT

In the present invention, when a power module is soldered to a heatsink, steam which is temperature-adjusted to at least the melting point of a solder is introduced from a steam generating tank into the flow path provided in the heatsink, the heatsink is heated and the solder is melted. Inert gas is introduced into a soldering tank from another route so as not to mix with the steam supplied to the heatsink. Voids in the solder are reduced and condensed by pressure regulation and as a result the negative impact of voids is eliminated.

### TECHNICAL FIELD

The present invention relates to a reflow soldering device and a reflow soldering method used when a power module is soldered in a soldering tank.

### BACKGROUND ART

A steam reflow soldering method in the related art achieves soldering with satisfactory solder wettability by performing soldering at an oxygen concentration of 300 ppm or below by heating and melting a material preliminarily applied to a soldered portion in a steam atmosphere of an inert liquid having a boiling point at least at a solder melting point (see, for example, Patent Document 1). The reflow soldering method in the related art, however, requires heating in a steam atmosphere and a pressure of the atmosphere cannot be reduced. This incapability raises a problem that an effective measure to suppress voids in the solder cannot be obtained. Further, because wettability cannot be enhanced by displacement with a reducing gas, there is another problem that cream solder, flux, or the like needs to be applied.

### CITATION LIST

### Patent Document

Patent Document 1: JP-A-2003-19590

### SUMMARY OF INVENTION

### Technical Problem

The invention is devised to solve the problems discussed above and has an object to provide a reflow soldering device and a reflow soldering method both of which achieve voids suppression and satisfactory solder wettability.

### Solution to Problem

A reflow soldering device of the invention includes: a soldered work to which solder is applied; a soldering tank in which to house a heating body that heats the soldered work; a vacuum pump with which an internal pressure of the soldering tank is reduced; a displacement gas tank from which an inert gas is introduced into the soldering tank; and a heat transfer medium supplying tank from which a temperature-adjusted heat transfer medium is supplied into a flow path provided in the heating body. The heat transfer medium is introduced into and discharged from the heating body by way of a route isolated from an internal space of the soldering tank. Soldering of the soldered work is performed with the solder that melts with heat of the heating body. The heat transfer medium is steam obtained by heating an inert liquid having a boiling point at least at a melting point of the solder or the inert liquid.

A reflow soldering method of the invention includes: a step of disposing a soldered work to which solder is applied on a heating body in a soldering tank; a step of reducing an internal pressure of the soldering tank; a step of introducing an inert gas into the soldering tank; a step of supplying a heat transfer medium which is temperature-adjusted at least to a melting point of the solder to a flow path provided in the heating body by a route isolated from an internal space of the soldering tank to melt the solder by heating the heating body and the soldered work; a step of reducing voids in the solder by reducing the internal pressure of the soldering tank; and a step of restoring the internal pressure of the soldering tank to at least a normal pressure to let the solder solidify.

### Advantageous Effects of Invention

According to the reflow soldering device of the invention, a flow path of the inert gas introduced into the soldering tank and a flow path of the heat transfer medium introduced to the heating plate are isolated from each other. It thus becomes possible to perform pressure regulation of the soldering tank for voids suppression and temperature adjustment of the heating body for enhancement of solder wettability in independent systems.

According to the reflow soldering method of the invention, it becomes possible to exactly control a temperature of the heating body and let the solder solidify under pressure at least at a normal pressure after voids are reduced by reducing an internal pressure of the soldering tank in which to house the soldered work. It thus becomes possible to make the voids in the solder smaller and hence to lessen a negative impact of the voids.

### BRIEF DESCRIPTION OF DRAWINGS

FIG. 1 is a view showing a configuration of a reflow soldering device according to a first embodiment of the invention.

FIG. 2 is a cross section used to describe a configuration of a power module of the invention.

FIG. 3 is a view showing a configuration of a reflow soldering device according to a second embodiment of the invention.

FIG. 4 is a view showing a configuration of a reflow soldering device according to a third embodiment of the invention.

FIG. 5 is a view showing a configuration of a reflow soldering device according to a fourth embodiment of the invention.

FIG. 6 is a cross section showing a configuration in a major portion of a steam pipe according to a fifth embodiment of the invention.

### DESCRIPTION OF EMBODIMENTS

### First Embodiment

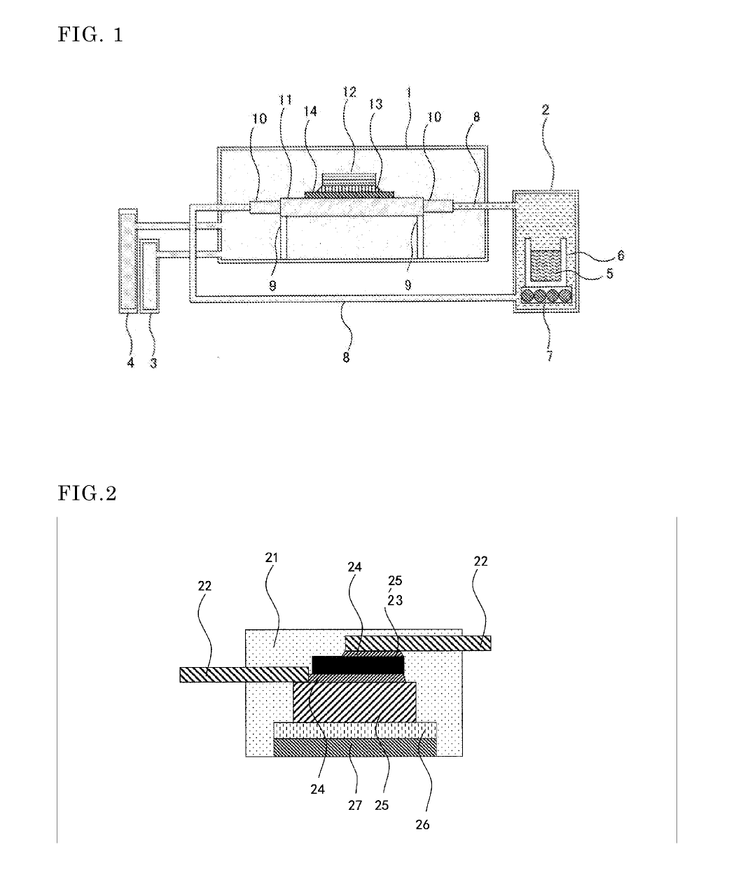

A first embodiment of the invention will be described using FIG. 1 and FIG. 2. FIG. 1 is a view showing a configuration of a reflow soldering device of the first embodiment. A flat plate-like heating plate (corresponds to a heating body) 11 is disposed in a soldering tank 1. Steam pipes (corresponding to a pipe portion) 8 extending from a steam generating tank 2 as a heat transfer medium supplying tank are attached to the heating plate 11 via joint portions (heating plate pipes) 10. Also, a pipe from a vacuum pump 3 and a pipe from a displacement gas tank 4 are connected and fixed to the soldering tank 1. A heater 7 is disposed at a bottom of the steam generating tank 2 and an inert liquid case 6 storing an inert liquid 5 is fixed on the heater 7. A base plate 14 is disposed onto the heating plate 11 on a support 9 and a layer of solder 13 is formed on the base plate 14 in the soldering tank 1. A power module 12 is placed on the base plate 14 via the solder 13. A soldered work corresponds to a laminated body including the base plate 14, the solder 13, and the power module 12. The base plate 14 to be integrated with the power module 12 by the solder 13 is taken out from the soldering tank 1 after the solder 13 thermally cures. On the contrary, because it is configured in such a manner that the heating plate 11 is installed to the soldering tank 1, the heating plate 11 held by the support 9 or the like is left intact in the tank.

A cross section of the power module 12 is shown in FIG. 2 by way of example. The power module 12 of FIG. 2 is of a resin encapsulation type encapsulated, for example, by mold resin (epoxy resin) 21 and a power semiconductor device 23 is disposed inside. The power semiconductor device 23 is fixed to a metal plate (heat spreader) 25 by internal solder 24. Also, terminals 22 for communications with outside devices are fixed to the power semiconductor device 23 by the internal solder 24. The power module 12 includes metal foil 27 across a bottom surface and the metal foil 27 has a metal surface to be joined to the solder 13. Examples of a shape and dimensions of the power module 12 will now be described. The power module 12 includes, between the metal plate 25 and the bottom surface, an insulation resin layer 26 and the metal foil 27 both having a larger projection outer shape on a vertical surface than the metal plate 25. The metal foil 27 is exposed to the bottom surface of the power module 12.

The metal foil 27 is 100-μm-thick copper foil. The insulation resin layer 26 is a 200-μm-thick layer of epoxy resin impregnated with a BN filler. The metal plate 25 is a copper plate having a thickness of 1 mm to 3 mm. The power semiconductor device 23 is 200-μm-thick silicon.

The internal solder 24 between the metal plate 25 and the power semiconductor device 23 is a layer made of Sn and additive elements and having a thickness of 50 μm to 200 μm. The additive elements include Ag, Cu, Ni, Sb, In, Bi, and so on.

When the resin-encapsulated power module 12 as above is heated to the extent that a temperature reaches a melting point of the internal solder 24 or above, there occurs an inconvenience that the internal solder 24 runs along an internal interface due to volume expansion and flows out by breaking the mold resin 21. Such being the case, there is a problem that the power module 12 is not heated to a temperature at or above a melting point of the internal solder 24 in a soldering process of the power module 12.

The reflow soldering device according to the first embodiment of the invention includes a soldered work to which the solder 13 is applied, a soldering tank 1 in which to house a heating body (heating plate 11) that heats the soldered work, the vacuum pump 3 by which an internal pressure of the soldering tank 1 is reduced, the displacement gas tank 4 from which an inert gas is introduced into the soldering tank 1, and a heat transfer medium supplying tank (steam generating tank 2) from which a temperature-adjusted heat transfer medium is supplied into a flow path provided in the heating plate 11. The reflow soldering device is configured in such a manner that the heat transfer medium is introduced into and discharged from the heating plate 11 by way of a route isolated from an internal space of the soldering tank 1 and that the soldered work is soldered with the solder 13 that melts with heat of the heating plate 11. Hence, by introducing steam (heat transfer medium) into the flow path provided in the heating plate 11, an internal temperature of the heating plate 11 is maintained at a temperature that does not exceed the boiling point of the inert liquid. Accordingly, the base plate 14 is heated to a temperature as high as the boiling point of the inert liquid. In other words, it becomes possible to introduce the heat transfer medium that is temperature-adjusted to the boiling point of the inert liquid to the heating plate 11. Consequently, the reflow soldering device becomes capable of regulating the heating temperature exactly with respect to the boiling point of the solder 13.

It should be noted that it is necessary to use the internal solder 24 in the power module 12 having a melting point higher than the melting point of the solder layer 13 used to join the base plate 14 and the power module 12 together. There is, however, no so-called lead-free solder such that has a significant difference in melting point and solder that can be actually obtained has a difference, for example, of only about 20 degrees. More specifically, there is a need for a soldering method by which a heating temperature can be regulated exactly within a range of a difference between the melting points of the internal solder 24 and the solder 13 when the power module 12 configured as above is mounted. Such a soldering method can be achieved in this heating system.

The solder 13 between the power module 12 and the base plate 14 not only has to play a role of joining and fixing the members but also has to be furnished with a heat-releasing function. Hence, an inconvenience occurs in a case where there are voids in the solder 13, that is to say, there is a risk that a temperature of the power semiconductor device 23 rises above an allowable temperature due to heat rejection. It is therefore necessary to strictly control a size of largest voids. To this end, the reflow soldering device of the invention includes the vacuum pump 3 and the displacement gas tank 4, so that sizes of voids can be controlled by reducing an internal pressure of the soldering tank 1 in a system different from the one provided for the heat transfer medium used to melt the solder 13 and also by displacing an atmosphere of an internal space by an inert atmosphere with a displacement gas.

The reflow soldering method of the invention will now be described.

Initially, a solder layer is formed by applying paste of the solder 13 on the base plate 14 and the power module 12 is placed on the solder 13. The members to be bonded by the solder 13 are thus laminated. The internal solder 24 in the power module 12 has a composition, for example, of Sn-5Pb and a melting point of 235° C. Also, the solder 13 has a composition, for example, of Sn-3.5Ag-0.5Bi-8In and a melting point of 214° C. It should be appreciated, however, that the invention is not limited to these examples and any combination is available as long as the melting point of the solder layer 13 is lower than the melting point of the internal solder 24 by at least 10° C. (Step 1).

Subsequently, the work obtained in Step 1 is placed on the heating plate 11 in the soldering tank 1 in such a manner that the work comes into contact with the base plate 14 (Step 2).

Subsequently, an internal pressure of the soldering tank 1 is reduced by the vacuum pump 3 to introduce an inert gas from the displacement gas tank 4, so that an atmosphere is displaced by an inert atmosphere at normal temperature. The inert gas is a low oxygen gas and examples include but not limited to N₂, H₂, or a mixed gas of these gases (Step 3).

Subsequently, steam is generated by heating the inert liquid 5 in the inert liquid case 6 by the heater 6 in the steam generating tank (heat transfer medium supplying tank) 2 and the heating plate 11 is heated with the steam to a temperature as high as at least the melting point of the solder 13. In this instance, the inert liquid 5 is, for example, Galden, and has a boiling point of 225° C. Hence, a temperature of the steam introduced into the heating plate 11 from the steam generating tank 2 by way of the steam pipes 8 is adjusted to 225° C. The heating plate 11 can be therefore heated to 225° C. Because the internal solder 24 in the power module 12 has the boiling point of 235° C., the internal solder 24 does not melt. On the contrary, because the solder 13 has the melting point of 214° C., solder forming the solder 13 melts and the base plate 14 and the power module 12 can be soldered. By raising a temperature of the heating plate 11 while reducing an internal pressure of the soldering tank 1 by the vacuum pump 3 in this manner, a gas trapped within the solder layer expands in the solder 13 in a melted state and moves to the outside from under the power module 12 (air bubbles that expand more when the pressure is reduced and the temperature is raised further reach an edge of the solder layer). When the gas reaches an outside edge, the gas is discharged to the outside of the solder 13 and voids disappear (Step 4).

In Step 4, it is necessary that the boiling point of the inert liquid 5 is at least as high as the melting point of the solder 13 and lower than the melting point of the inner solder 24. Inert liquids known to date, however, are a mixture and the boiling point thereof varies within a range of about ±3° C. For example, the boiling point of pure water is 100° C. However, there is a phenomenon that when pure water is mixed, for example, with alcohol, the resulting mixture does not show a specific boiling point. Likewise, a boiling point of mixtures varies within a certain range of temperature.

In a case where the internal solder 24 melts due to inadequate temperature control, volume expansion of about 5% occurs and an internal pressure rises to the extent that the encapsulation resin is broken. This breakage causes an inconvenience that a short circuit occurs in conductors initially provided in a mutually isolated manner. In order to forestall the occurrence of such an inconvenience, it is necessary to secure a temperature difference between the melting points of the internal solder 24 and the solder 13 and the boiling point of the inert liquid in consideration of a variance of the boiling point of the mixture.

It has been described that the heating plate 11 is heated to a temperature as high as the boiling point of the inert liquid 5 in Step 4 above, and it is preferable that this temperature rising process is carried out in two steps. By temporarily maintaining the temperature near the melting point of the solder 13 in a first step to make a temperature of joined surfaces of the base plate 14 and the power module 12 homogenous, and by raising the temperature above the melting point of the solder 13 in a second step, it becomes possible to lessen a temperature gap between the base plate 14 and the power module 12 when the solder 13 melts.

Also, heat release from the power module 12 to the soldering tank 1 can be suppressed by covering the heating plate 11 and the power module 12 with an unillustrated heat insulating material. Hence, a temperature rise of the internal solder 24 in the power module 12 that requires strict control can be suppressed to the minimum necessary level.

Thereafter, the internal pressure of the soldering tank 1 is restored to a normal pressure by introducing a low oxygen gas (N₂, H₂, or a mixed gas thereof) therein from the displacement gas tank 4. Then, the steam generating tank 2 is stopped by turning OFF the heater 7 to lower the temperature of the work to at least the melting point of the solder 13 (Step 5).

Even when air bubbles that did not develop large enough to reach the edge (a surface portion to which the solder layer is exposed) of the solder 13 are present in preceding Step 4, a volume of the voids is compressed as the internal pressure restores to the normal pressure in Step 5 and the voids become smaller to a size small enough not to interfere with heat release. Hence, it becomes possible to let the solder 13 solidify while voids such that act against heat transfer are absent in the solder 13. Soldering of the work is thus completed.

A processing time may be reduced by actively cooling the solder 13 for solidification. One of methods to achieve this cooling is, for example, to introduce a gas or a liquid at or below the melting point of the solder 13 into the flow path of the heat transfer medium in the heating plate 11. Besides this example method, solidification of the solder 13 can be accelerated by cooling the heating plate 11 by methods as follows. That is, a pipe other than the steam pipes (pipe portion 8) used to introduce the inert liquid 5 is provided and connected to the flow path in the heating plate 11, so that a cooling medium is infused into the heating plate 11. Alternatively, the inert liquid 5 is cooled by a cooling device and infused into the heating plate 11 using the same flow path it flew at the time of heating.

The above has described a case where the internal pressure of the soldering tank 1 is restored to a normal pressure when the solder 13 is solidified in Step 5. In order to reduce the negative impact of the voids, it is effective to have a normal pressure or an atmosphere with a higher pressure as the internal pressure of the soldering tank 1. Also, it is necessary that a process is carried out in such a manner that solder solidification starts under normal pressure or in an atmosphere with a higher pressure.

For example, in a case where the internal pressure is not restored to the normal pressure (the internal pressure is still low) before the temperature of the solder 13 drops to the solidification point, the solder 13 solidifies while compression of the voids is taking place and the voids are left in a slightly large size. Such being the case, when a low oxygen gas is supplied to the soldering tank 1, it is preferable to apply a pressure at least as high as the normal pressure so that voids in the solder 13 become further smaller than under normal pressure. By lowering the temperature of the solder 13 to the solidification point to let the solder 13 solidify in this state, sizes of the voids can be further smaller than in a case where the solder 13 is let solidify under normal pressure.

By using the inert liquid used to heat the solder and the gas used to reduce voids during soldering in a state where the former and the latter are not mixed with each other for the soldering, it consequently becomes possible to achieve soldering with fewer voids while enhancing the wettability of the solder 13. Assume that a gas of the evaporated inert liquid is introduced directly into an atmosphere in the soldering tank 1, then there occurs a problem that heating cannot be applied during a pressure reduction. This problem, however, is solved in the soldering method using the soldering device of this embodiment because the system of the gas is isolated.

FIG. 1 shows a case where the two steam pipes 8 are connected to the steam generating tank 2. By circulating the steam in such a manner that steam heated to a temperature at least as high as the solder melting point is supplied to the heating plate 11 via the pipe connected to the heating plate 11 from an upper part of the steam generating tank 2 and the steam is returned from the heating plate 11 to the steam generating tank 2 via the pipe connected to a lower part of the steam generating tank 2, it becomes possible to circulate the heat transfer medium by utilizing a property that steam rises above when it is hot and drops when cooled. Also, it may be configured in such a manner that the flow path of the heat transfer medium provided in the heating plate 11 runs throughout the heating plate 11 by providing multiple directions as a steam introduction direction to make the temperature in the heating plate 11 homogeneous.

The above has described a case where the steam is obtained by heating the inert liquid 5 and the steam is supplied to the heating body as the heat transfer medium. It should be appreciated, however, that the same advantage can be obtained when a substance in a liquid state at the melting point of the solder 13 is used and a liquid of this substance is supplied to the heating body as the heat transfer medium. It is, however, necessary in this case to provide an accommodation by providing a liquid temperature adjusting tank instead of the steam generating tank 2 and providing a pump used to transport a hot liquid supplied from this tank.

Also, the heating plate 11, which is a plate-like member, has been described as the heating body in the case above. It should be appreciated, however, that a heating body of a shape other than the plate shape is also available as long as the member is of a structure to which the soldered work can be brought into close contact and heat can be transferred as with the heating plate 11. Further, the above has described a case in which the heating plate 11 is disposed in the soldering tank 1 so as to have a horizontal work placement surface with reference to FIG. 1. It should be appreciated, however, that it goes without saying that the heating plate 11 may be disposed in a standing position so that the work placement surface of the heating plate 11 stands upright or disposed in another direction as long as the work can come into contact with the work placement surface.

### Second Embodiment

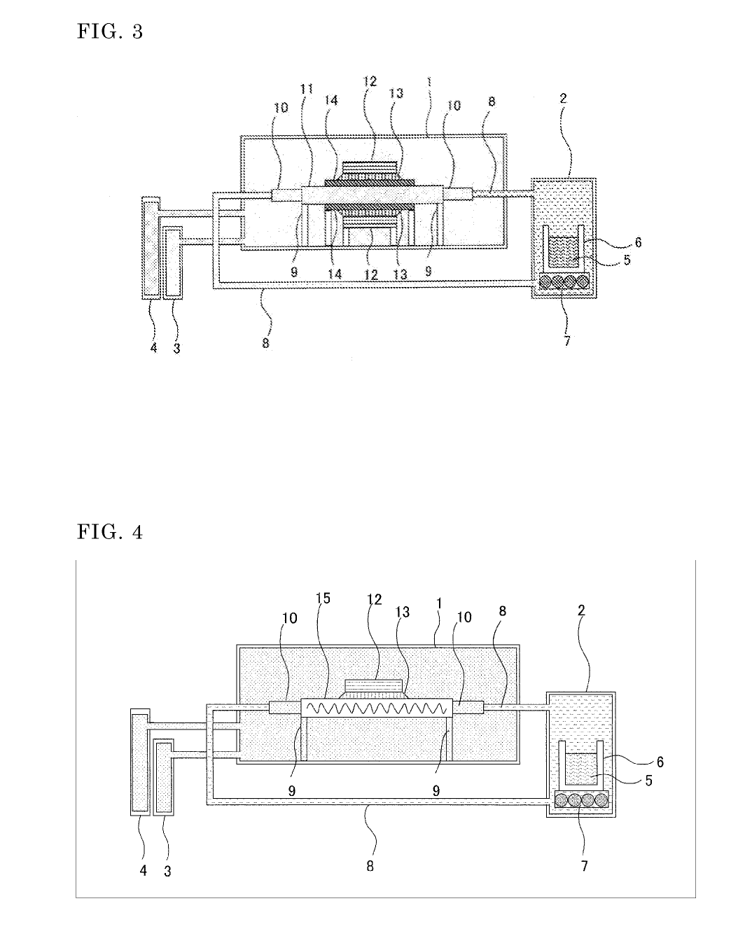

The first embodiment above has described a case where soldering is performed by disposing the soldered work on one surface of the heating plate 11. It is, however, also possible to configure in such a manner that soldered works are disposed on both surfaces of the heating plate 11 as is shown in FIG. 3 which is a cross section showing a configuration in a major portion of a reflow soldering device of a second embodiment. As is shown in FIG. 3, in a case where the soldered work is brought into contact with a back surface of the heating plate 11, supports 9 on which to support the base plate 14 and the power module 12 are disposed in the soldering tank 1 so that soldering is performed while the work is supported to prevent the work from falling off.

It is further possible to dispose the heating plate 11 upright in the soldering tank 1. In this case, too, it is necessary to perform soldering processing while preventing the work from falling off by fixedly holding the work 11 with a support member for the work to be in close contact with the heating plate 11 or by providing a suction holding mechanism on the side of the heating plate 1 to hold the work by suction.

### Third Embodiment

The first embodiment above has described that the heating body is the heating plate 11 and that soldering is performed by fixedly disposing the heating plate 11 in the soldering tank 1 and disposing the soldered work so as to be in contact with the heating plate 11 for the former to be heated by the latter. A third embodiment will describe a reflow soldering device and a reflow soldering method configured as is shown in FIG. 4. More specifically, FIG. 4 is a cross section showing a configuration in a major portion of the reflow soldering device of the third embodiment. Herein, the heating body is a heatsink 15 that is a part of the soldered work and an integrated soldered work (including the heatsink 15, the solder 13, and the power module 12) obtained by soldering the power module 12 to the heatsink 15 itself is taken out from the soldering tank 1.

The heatsink 15 is of a flat plate shape and includes inside a closed space used as a flow path that servers as a heat transfer medium. Also, the heatsink 15 includes joint portions (heatsink pipes) 10 serving as an inlet and an outlet of a pipe that introduces steam of the evaporated inert liquid 5. The flow path in the heatsink 15 and the steam generating tank 2 are connected to each other with steam pipes 8. As in the first embodiment above, a system of a gas of the evaporated inert liquid 5 and a system in the soldering tank 1 are isolated from each other.

The reflow soldering device of the third embodiment makes it possible to connect the power module 12 to the heatsink 15 with fewer voids. For example, a heatsink used as the heatsink 15 has a thickness of about 10 mm and includes a coolant flow path inside.

In the third embodiment where the work is soldered to the heatsink 15, processing is carried out in the following procedure. That is, the heatsink 15 is attached inside the soldering tank 1 by connecting the joint portions (heatsink pipes) 10 serving as connection portions on the side of the heatsink 15 to the steam pipes 8 pulled into the soldering tank 1 so that the heat transfer medium flow path in the heatsink 15 is connected to the steam pipes 8. Then, cream of solder 13 is applied on the top surface of the heatsink 15 and soldering is performed after the power module 12 is placed on the solder 13. The heatsink 15 is then disconnected from the joint portions 10 after the solder 13 solidifies and the soldered work after the soldering processing (including the joint potions 10; the joint portions 10 may be provided by cutting a part of the heatsink 15 and therefore an integral part of the heatsink 15) is taken out from the soldering tank 1. Alternatively, the steam pipes 8 may be provided with joints to the joint portions 10 to facilitate connection and disconnection.

It is suitable to use aluminum or copper as a material of the heatsink 15. It has been extremely difficult to heat such a 10-mm-thick object with a large heat capacity to an exact temperature. However, the soldering device of this embodiment makes it possible to perform soldering under reduced pressure in a state where the heatsink is maintained at a boiling point of the inert liquid.

### Fourth Embodiment

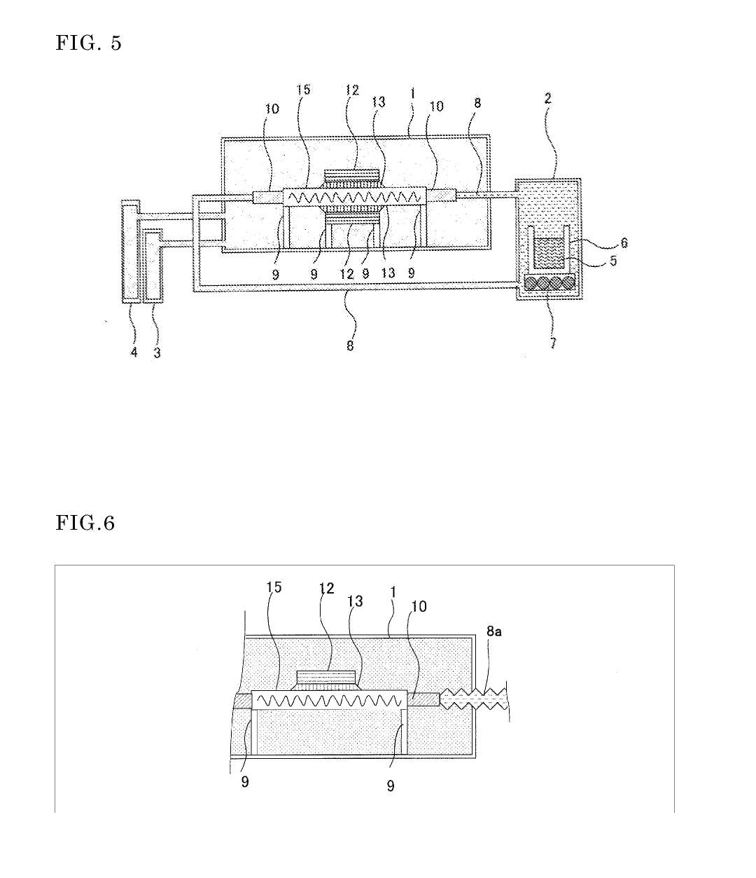

A fourth embodiment of the invention will now be described using FIG. 5. In the fourth embodiment, as in the third embodiment above, the soldered work is of a structure in which the heatsink 15 is integrated with the power module 12 with the solder 13. The third embodiment above has described a case where soldering is performed by placing the power module 12 on the heatsink 15 of a flat plate shape via the solder 13 only on the top surface extending in a horizontal direction. In contrast, in the fourth embodiment, the solder 13 is applied not only to the top surface but also to the back surface of each power module 12 and the power modules 12 are attached to the solder 13 on the both sides of the heatsink 15, so that a plurality of the power modules 12 can be soldered collectively at the same time while the power modules 12 are held on the support 9. Because a method of evaporating the inert liquid is used, a surface temperature of the heatsink 15 can be placed under strict temperature control. It thus becomes possible to perform soldering on the both surfaces without allowing the internal solder 24 to melt.

The third and fourth embodiments above have described a case where the heatsink 15 of a flat plate shape is joined to the joint portions 10 in such a manner that the planes are provided in a horizontal direction in the soldering tank 1. However, by additionally providing a support member that holds the power module 12 while the power modules 12 is joined in close contact with the surface of the heatsink 15 via the solder 13, it becomes possible to hold the heatsink 15 in the soldering tank 1 in a standing position.

### Fifth Embodiment

A fifth embodiment of the invention will now be described. In the third and fourth embodiments above, it is necessary to form the steam pipes 8 to be connectable to and disconnectable from the joint portions 10 connected to the heatsink 15. Also, because an internal pressure of the soldering tank is reduced during the soldering process, when a material that contracts under reduced pressure is used, stress concentrates on the connected part of the steam pipe 8 and the joint portion 10 and a leakage of steam may possibly occur.

Such being the case, as is shown in FIG. 6, the fifth embodiment will describe a case where the steam pipe 8 is formed of an elastic joint 8a of an accordion structure either at least in a joined part to the joint portion 10 or entirely, so that concentration of stress on the connected part can be avoided by letting stress be dispersed and absorbed in an accordion portion. By using the elastic joint 8a of the accordion structure, a work allowance is increased when the joint portion 10 and the elastic joint 8a are connected to and disconnected from each other not only during the pressure reducing process but also during a work of attaching the heatsink 15 in the soldering tank 1 and a work of removing the former from the latter. Hence, there can be achieved an advantage that the processing is performed effectively.

It goes without saying that an advantage of dispersing stress applied during a pressure reducing step in the soldering process can be achieved also in the first embodiment above by replacing a part of the steam pipes 8 connected to the joint portions 10 with the elastic joint 8a described above.

### Industrial Applicability

The invention is applicable when an electronic part is soldered to a plate-like soldered work, such as a printed circuit board.

### Reference Signs List

1: soldering tank

2: steam generating tank (heat transfer medium supplying tank)

3: vacuum pump

4: displacement gas tank

5: inert liquid

6: inert liquid case

7: heater

8 and 8b: steam pipe (pipe portion)

8a: elastic joint

9: support

10: joint portion

11: heating plate

12: power module

13: solder

14: base plate

15: heatsink

21: mold resin

22: terminal

23: power semiconductor device

24: internal solder

25: metal plate (heat spreader)

26: insulation resin layer

27: metal foil

1. A reflow soldering device, characterized by comprising:
a soldered work to which solder is applied;
a soldering tank in which to house a heating body that heats the soldered work;
a vacuum pump with which an internal pressure of the soldering tank is reduced;
a displacement gas tank from which an inert gas is introduced into the soldering tank; and
a heat transfer medium supplying tank from which a temperature-adjusted heat transfer medium is supplied into a flow path provided in the heating body,
wherein:
the heat transfer medium is introduced into and discharged from the heating body by way of a route isolated from an internal space of the soldering tank;
soldering of the soldered work is performed with the solder that melts with heat of the heating body; and
the heat transfer medium is steam obtained by heating an inert liquid having a boiling point at least at a melting point of the solder or the inert liquid.

2. The reflow soldering device according to claim 1 characterized in that:
the heating body is a plate-like member provided fixedly in the soldering tank and formed in such a manner that the soldered work is disposed to be in contact with the heating body; and
the soldered work is disposed on one surface or both surfaces of the heating body.

3. The reflow soldering device according to claim 2 characterized in that:
the heating body is a heatsink formed of a plate-like member that is joined to the soldered work with the solder and formed integrally with the soldered work.

4. The reflow soldering device according to claim 1, characterized by further comprising:
a pipe portion that is pulled into the soldering tank from the heat transfer medium supplying tank to transport the heat transfer medium,
wherein the pipe portion is an elastic joint of an accordion structure.

5. A reflow soldering method, characterized by comprising:
disposing a soldered work to which solder is applied on a heating body in a soldering tank;
reducing an internal pressure of the soldering tank;
introducing an inert gas into the soldering tank;
supplying a heat transfer medium which is temperature-adjusted at least to a melting point of the solder to a flow path provided in the heating body by a route isolated from an internal space of the soldering tank to melt the solder by heating the heating body and the soldered work;
reducing voids in the solder by reducing the internal pressure of the soldering tank; and
restoring the internal pressure of the soldering tank to at least a normal pressure to let the solder solidify.

6. The reflow soldering method according to claim 5, characterized by further comprising:
connecting a joint portion connected to a heatsink serving as the heating body to a pipe portion provided in the soldering tank to introduce an inert gas therein; and
disconnecting the joint portion and the pipe portion after the soldered work is soldered to the heatsink and taking the heatsink from the soldering tank.

7. The reflow soldering method according to claim 5, wherein:
steam obtained by heating an inert liquid having a boiling point at least at the melting point of the solder is used as the heat transfer medium.

8. The reflow soldering method according to claim 5, wherein:
an inert liquid heated to at least the melting point of the solder is used as the heat transfer medium.

9. The reflow soldering device according to claim 2, characterized by further comprising:
a pipe portion that is pulled into the soldering tank from the heat transfer medium supplying tank to transport the heat transfer medium,
wherein the pipe portion is an elastic joint of an accordion structure.

10. The reflow soldering device according to claims 3, characterized by further comprising:
a pipe portion that is pulled into the soldering tank from the heat transfer medium supplying tank to transport the heat transfer medium,
wherein the pipe portion is an elastic joint of an accordion structure.

11. The reflow soldering method according to claim 6, wherein:
steam obtained by heating an inert liquid having a boiling point at least at the melting point of the solder is used as the heat transfer medium.

12. The reflow soldering method according to claim 6, wherein:
an inert liquid heated to at least the melting point of the solder is used as the heat transfer medium.
